(19) United States
(12) Patent Application Publication
(10) Pub. No.: US 2015/0109776 A1
(43) Pub. Date: Apr. 23, 2015

(54) LED Flash Display

(71) Applicant: Wanwen He, Shanghai (CN)

(72) Inventor: Wanwen He, Shanghai (CN)

(73) Assignee: Golconda Holdings, LLC, Bay St. Louis, MS (US)

(21) Appl. No.: 14/320,538

(22) Filed: Jun. 30, 2014

(30) Foreign Application Priority Data
Sep. 23, 2013 (CN) 201310278333.6

(51) Int. Cl. G09F 13/00; G09F 13/04; F21V 23/00

(52) U.S. Cl. CPC G09F 13/005; F21V 23/003; G09F 13/04; F21Y 2101/02
USPC 362/235

(57) ABSTRACT

The invention relates an LED flash-glare screen light-box, which includes sequentially arranged layers, from top to bottom, including a transparent glass, a light film, a transparent side layer, a LED luminescent panel, a fixed bar and a fixed back plane. The apparatus also includes an outer frame, which holds the transparent glass, the backplane and all other layers together. The LED light board has a controller and a multimedia card reader port. This controller connects to a multimedia card reader port, and is also connected to a power source, and is controlled by a switch. The thickness of the frame is between 3.2 to 10 centimeters. The LED flash-glare screen light-box can be either one-sided or double-sided, and both types can be programmed to perform multi-screen rolling-flashes.

### CROSS-REFERENCE TO RELATED APPLICATIONS

The present application claims benefit of priority to Chinese Pat. Application Ser. No. 201310278333.6, and entitled FLASH-GLARE SCREEN BOX (He), which is hereby incorporated by reference herein in its entirety.

### FIELD OF INVENTION

The invention generally relates to programmable light emitting diode (“LED”) or other illuminated panels for signage or advertising.

### BACKGROUND OF THE INVENTION

Light boxes are commonly used in the advertising industry for presenting illuminated advertisements and signage. The majority of commercially available light boxes use a form of internal lighting technology. An exterior layer of the boxes may contain printed materials which display advertising screens or other signage. Light boxes can be very bright in different environmental conditions and they are not limited by outside lighting conditions. In addition, light boxes display vivid colors compared to non-luminescent screens.

However, the traditional light boxes have existed for decades, and visual fatigue is common. In addition, performance of traditional light boxes is limited and the quality of the illumination and signage cannot be guaranteed. Existing light boxes may display lifeless and rigid screens and the lighting may be uneven.

### SUMMARY OF THE INVENTION

The objective of the present invention is to provide a newly designed LED flash-glare screen light-box, which can solve the above-mentioned disadvantages of the current light-boxes.

The present invention improves over the basic, uneven, and unchanging illumination of existing light boxes by employing an LED light panel, which utilizes multiple LED lights arranged on one or more LED panels. These LED light panels are in turn connected to a controller. The light box is supported by a frame, which holds several layers together, including a layer of transparent glass, a light film, a transparent edge layer, a set of LED light panels, fixed bars and backplane. The controller connects to a multimedia card reader port and a power source with a switch. The frame may have a thickness of 3.2-10 cm.

The present invention improves over the prior art by providing a light box that is thinner, brighter, more vivid, programmable, and that may even be animated. The light box may be as thin as 3.2 centimeters. The present invention promotes environmental protection and saves energy through low maximum power consumption per square meter of 48 watts and an even lower minimum power consumption of 10 watts. The present invention is scalable, and can be made as large as 100 square meters. The screen of the present invention may also be programmed to flash with different patterns. The light box of the present invention can be used for both outdoor and indoor environments, and the content of the screen can be easily replaced. In addition, the LED lights can last a long-term, reducing the need for costly bulb replacements required by existing light boxes. Furthermore, using a USB interface or wireless transmitter docking, the flashing modes of the light box can be easily programmed using a computer or other compatible device. For example, a single-sided light box can switch between flashing on two or more screens, and a two-sided light box can be programmed to switch among multiple screens. In summary, the present invention provides a light box that requires lower maintenance, uses less power, provides greater customization, and produces a greater advertising effect than existing light boxes.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 provides one embodiment of a side cross-section view of a light box display panel according to the present invention.

FIG. 2 provides a set of light boxes according to one embodiment of the present invention.

FIG. 3 provides one embodiment of a single LED according to the present invention.

FIG. 4 provides one embodiment of a single small LED panel according to the present invention.

FIG. 5 provides one embodiment of a single large LED panel according to the present invention.

FIG. 6 provides one embodiment of a controller card according to the present invention.

FIG. 7 provides one embodiment of a schematic view of a controller card according to the present invention.

FIG. 8 provides one embodiment of light box frame according to the present invention.

FIG. 9A provides a perspective view of one embodiment of a light box with the light film partially peeled back, exposing the LED panels, according to the present invention.

FIG. 9B provides one embodiment of a light box with the light film partially peeled back, exposing the LED panels, according to the present invention.

FIG. 10 provides one embodiment of a controller card connected to an LED panel according to the present invention.

FIG. 11 provides an embodiment of a user interface for configuring an LED panel's IP address according to the present invention.

FIG. 12 provides an embodiment of a user interface for configuring an LED panel's IP address according to the present invention.

FIG. 13 provides an embodiment of a user interface for using SeehnSet to program a controller card according to the present invention.

FIG. 14 provides an embodiment of a user interface for importing or exporting a file to or from a controller card according to the present invention.

FIG. 15 provides an embodiment of a user interface for importing a file to send to a controller card according to the present invention.

FIG. 16 provides an embodiment of a user interface for importing a file to send to a controller card according to the present invention.

FIG. 17 provides an embodiment of a user interface for using SeehnSet to configure the settings of a controller card according to the present invention.

FIG. 18 provides an embodiment of a user interface for using SeehnSet to configure the hardware settings of a controller card according to the present invention.

FIG. 19 provides an embodiment of a user interface for confirming the configuration of the settings of a controller card according to the present invention.

FIG. 20 provides an embodiment of a user interface for using SeehnPlay to program the program of a light box according to the present invention.

FIG. 21 provides an embodiment of a user interface for using SeehnPlay to program the program of a light box according to the present invention.

FIG. 22 provides an embodiment of a user interface for using SeehnPlay to program the program of a light box according to the present invention.

FIG. 23 provides an embodiment of a user interface for using SeehnPlay to configure the settings of a light box display according to the present invention.

FIG. 24 provides an embodiment of a user interface for using SeehnPlay to create a new program window according to the present invention.

FIG. 25 provides an embodiment of a user interface for using SeehnPlay to create a new program window according to the present invention.

FIG. 26 provides an embodiment of a user interface for using SeehnPlay to edit program text according to the present invention.

FIG. 27 provides an embodiment of a user interface for using SeehnPlay to program the program of a light box according to the present invention.

FIG. 28 provides an embodiment of a controller card with LED panel programmed to display text configured in SeehnPlay and SeehnSet according to FIGS. 11-27 according to the present invention.

### DETAILED DESCRIPTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

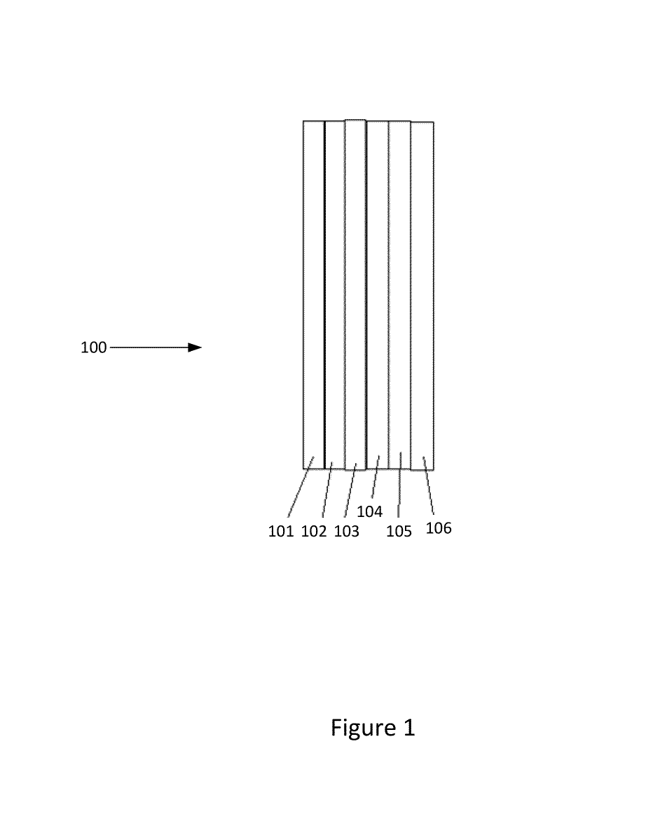

With reference now to FIG. 1, a cross-section view of a light box display panel 100 according to the present invention is provided. A flash-glare screen box, which includes a frame (not shown in this cross-section view of the panel), transparent glass layer 101, light sheet layer 102, transparent side layer 103, LED light panels 104, back panel 105, and fixed bar 106. In one embodiment, a frame would surround and enclose the perimeter of these sandwiched layers to hold all the six layers together. The LED light panels 104 connect to a controller, which furthers connects to a multimedia card reader port and a power source with a switch. The sandwiched panel layers and frame may have a thickness of 3.2 to 10 centimeters.

To program the light panels, a software program with process control is written into a memory card, which is then inserted into the multimedia card reader port. This program may be configured to control the LED light panels 105 through a USB port, or the LED light panels 105 can be remotely. The light panels 105 can be set to an always on, flashing, or a screen switching mode to display different contents or portions of the light sheet layer 102.

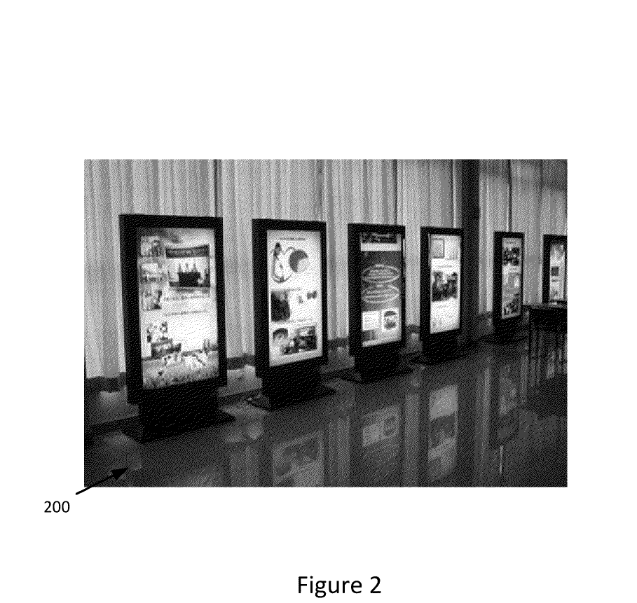

With reference now to FIG. 2, a set of light boxes 200 according to one embodiment of the present invention is provided. Light boxes seen in the set of light boxes 200 may have a rolling screen configuration. A rolling screen light-box can have multiple screens that may display different advertisements or signage. These screens may flash when they are rolling between screens. The light boxes 200 may also be programmed to flash in time with one another or in any other pattern desired by the user

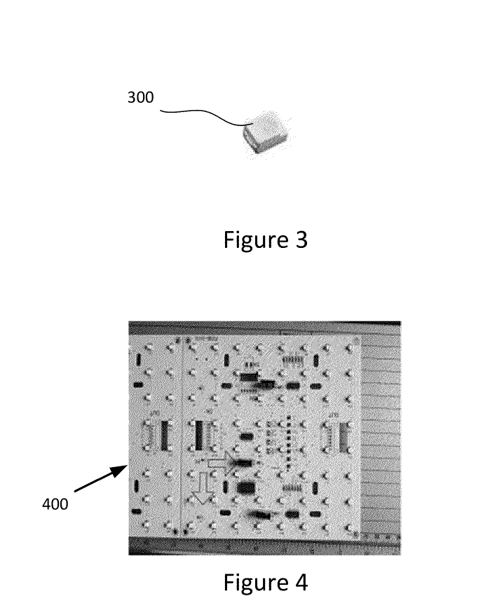

With reference now to FIG. 3, a single LED bead 300 is provided. In a preferred embodiment, the LED lamp bead 300 is an LED type 3528, on an Epistar 10×23 mm LED chip. The dimensions of the chip are 3.6 mm long, 2.8 mm wide, and 1.9 mm high. The LED bead 300 has a brightness of 7-8 lumens, a color temperature of 6000-6500 K, and a luminous intensity (in MCD) of 2500-2800 MCD. The LED bead 300 has a operating current of 200 mA, requires a voltage of 3.1-3.2 V, a reverse voltage of 5 V, and a pulse current of 100 mA with a pulse width of 0.1 mS and duty of 1/10. The bead 300 has an operating temperature of −40-80° C., a storage temperature of −40 to +100° C., and requires a soldering temperature of 260° C. for 10 seconds. The LED bead 300 of the preferred embodiment have a viewing angle of 120 degrees. Beads such as LED bead 300 may be concentrated to produce high brightness and strong color in the LED display. The LED bead 300 has a large viewing angle, large thermal resistance, and a low light decay process.

With reference now to FIG. 4, one embodiment of a small LED module 400 is provided. In a preferred embodiment, the Small LED module 400 is model P20 and contains only white LEDs. The LED module 400 is adapted to be used indoors, is 16×16 cm, and has a display resolution of 8×8. The module 400 operates in a static scan mode only, may use 85-260 V AC input, 5 V DC input, and may use 2-5 W of power when powering all 64 LEDs. The module 400 has a brightness of 480 LM and an expected life of 100,000 hours. The module 400 may be equipped with a serial, USB, IR remote, wireless GSM, or GPRS wireless interface module.

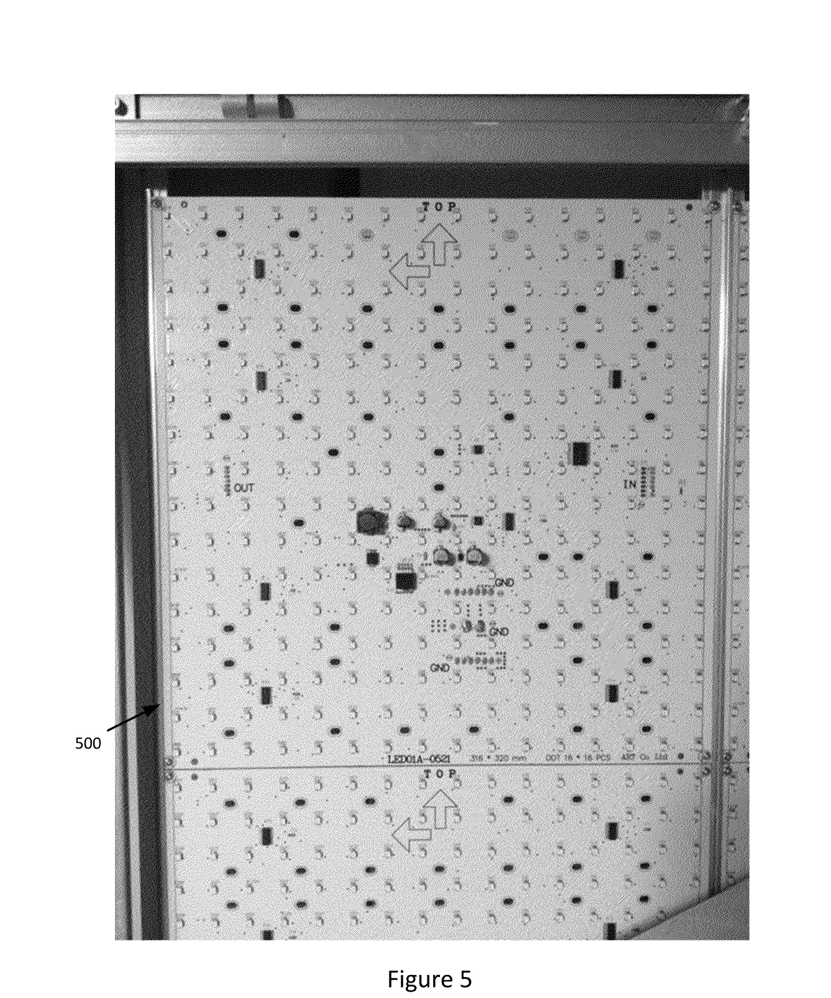

With reference now to FIG. 5, one embodiment of a large LED module 500 is provided. In a preferred embodiment, the large LED module 500 is model P20 and contains only white LEDs. The LED module 500 is adapted to be used indoors, is 32×32 cm, and has a display resolution of 16×16. The module 500 operates in a ⅛ scan mode, may use 85-260 V AC input, 24 V DC input, and may use 8-20 W of power when powering all 256 LEDs. The module 500 has a brightness of 1800 LM and an expected life of 100,000 hours. The module 500 may be equipped with a serial, USB, IR remote, wireless GSM, or GPRS wireless interface module.

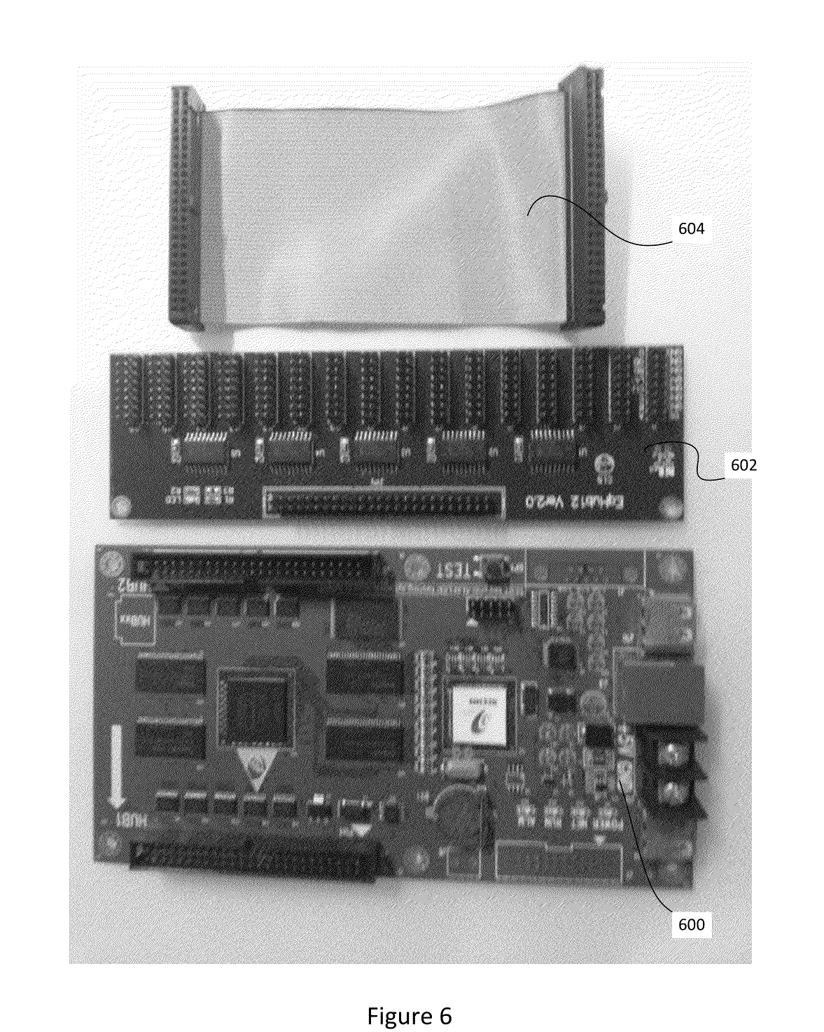

With reference now to FIG. 6, one embodiment of a controller card 600, connection hub 602, and controller cable 604 is provided. The control card 600 connects to the connection hub 602 via controller cable 604. A set of LED modules such as small LED module 400 seen in FIG. 4 may be connected to the connection hub 602 and controlled by the controller card 600.

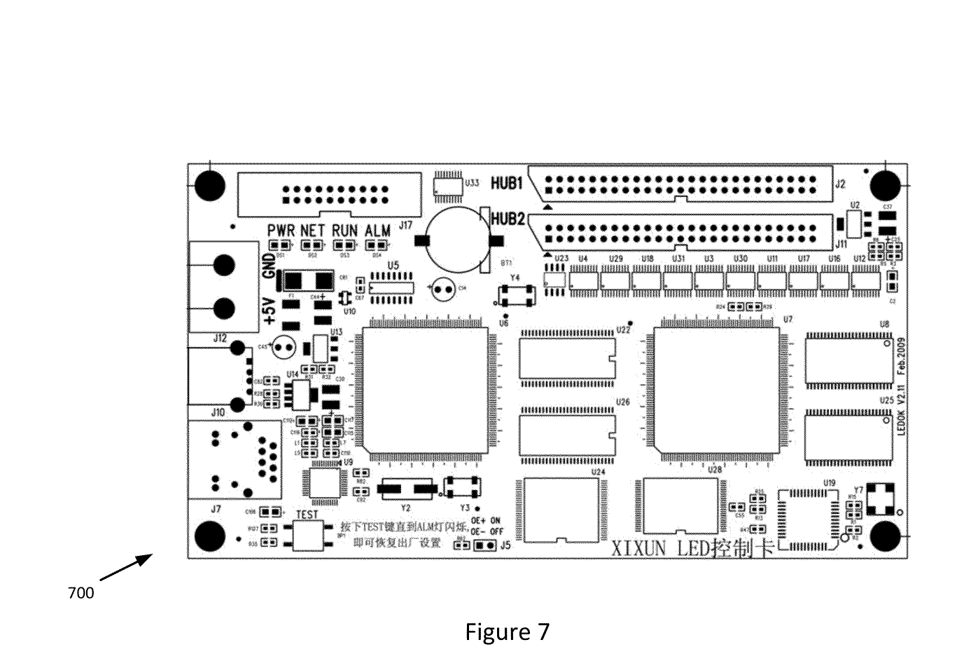

With reference now to FIG. 7, a schematic drawing of an embodiment the controller card 700 is provided. In one embodiment, the controller card 700 requires 4.5-5.5 V and is 166.1 mm×90.9 mm×20.4 mm in size. The controller card 700 is SeehnPlay compatible, supports intelligent parameter setting, and is compatible with static and 32 sweep scanning modes, as well as flashing line, and exporting data using a special module. The controller card 700 supports various programming and control software and allows for various modes of operation. The controller card 700 supports multiple languages including English, Chinese, and Spanish. The controller card 700 may control multiple light boxes or display windows and supports display modes and types such as file window, program window, single line of text, static text, clock window, table window, timer windows, temperature and humidity windows, has a timer function, multi-program playback, timed playback, and supports on-demand playback of programmed modules, programs, or windows.

Light boxes controlled by the control card 700 may have display resolutions of 256×128, 1024×32, 1024×512, or 4096×128. The control card 700 may also support additional resolutions though additional programming. The control card 700 may control both mono-chrome and full color LED displays and has 500 MB of storage that supports any partitioning method. The controller card 700 may operate LED modules in various scanning modes and supports displaying file types such as AVI, WMV, MPG, MOV, DAT, VOB, MP4, FLV, GIF, SWF, BMP, JPG, GIF, WMF, and ICO. The controller card 700 may also be used to display single-line text, multiple-line text, TXT files, and RTF files. The controller card 700 may also display a digital or analog clock.

The controller card 700 may have data connection ports such as USB, Ethernet, and serial, and may have communication modules for Wi-Fi, LAN, internet, and cellular communication. The controller card 700 may also have one or more sensors including a humidity sensor, brightness sensor, and an infrared remote controller.

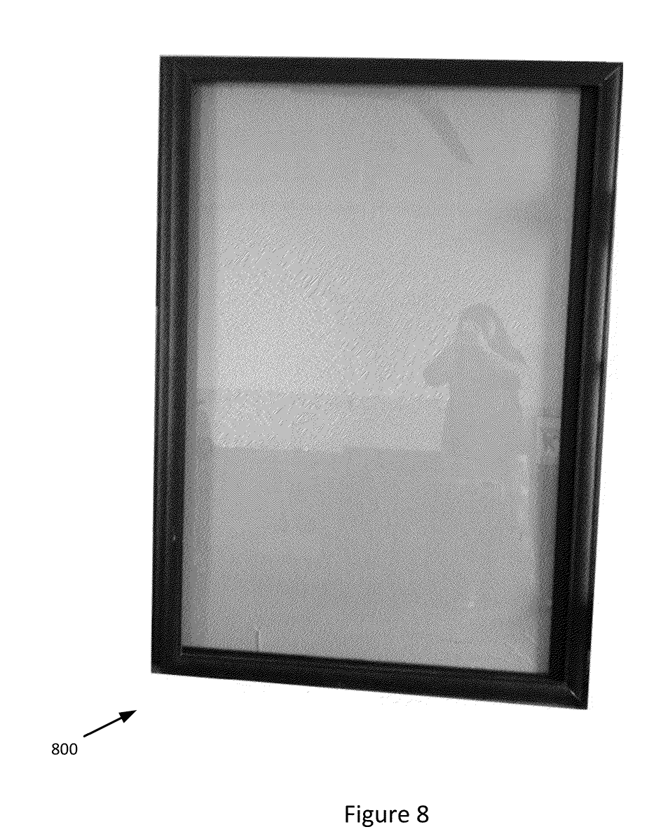

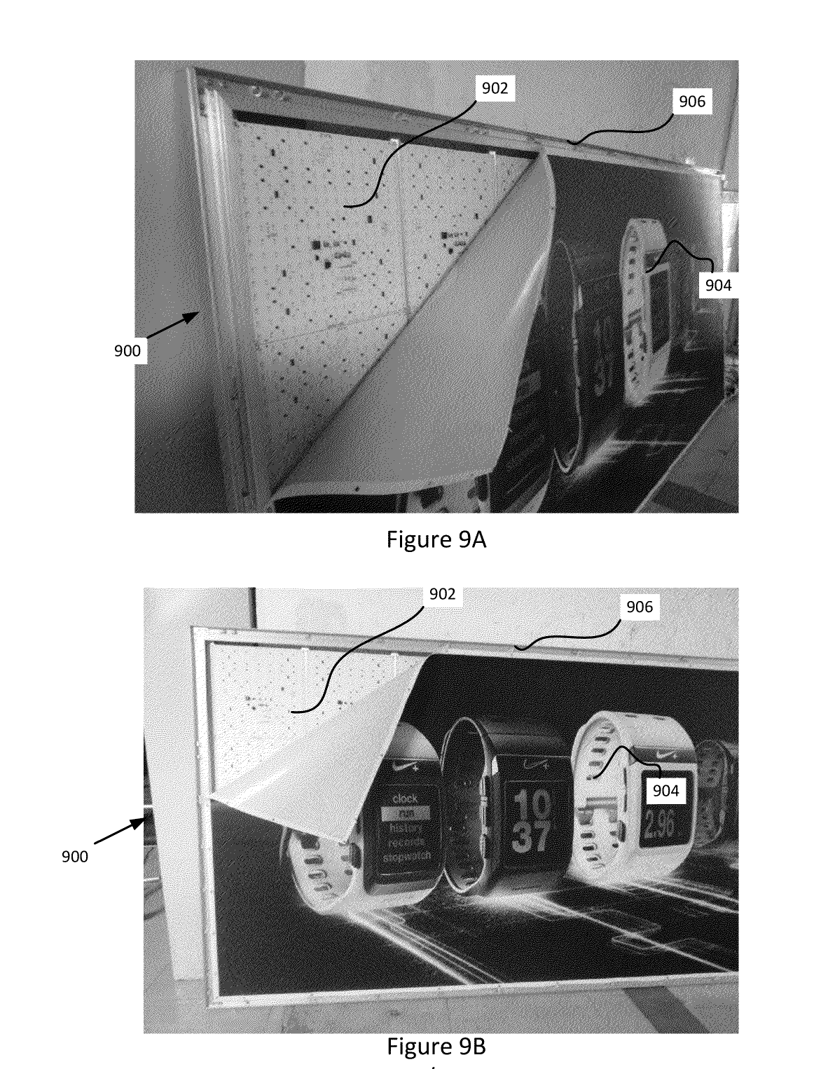

With reference now to FIGS. 9A and 9B, a perspective view and a front view of one embodiment of a light box 900 with the light film 904 partially peeled back, exposing the LED panels 902, is provided. The frame 906 secures the LED panels 902 and any transparent glass layer, such as transparent glass layer 101 in FIG. 1, and provides a structural support to the light box 900. A frame such as frame 800 shown in FIG. 8 may house the light box 900. The frame 800 may be made of wood, metal, or plastic and may have a glass, Plexiglas, or plastic transparent window.

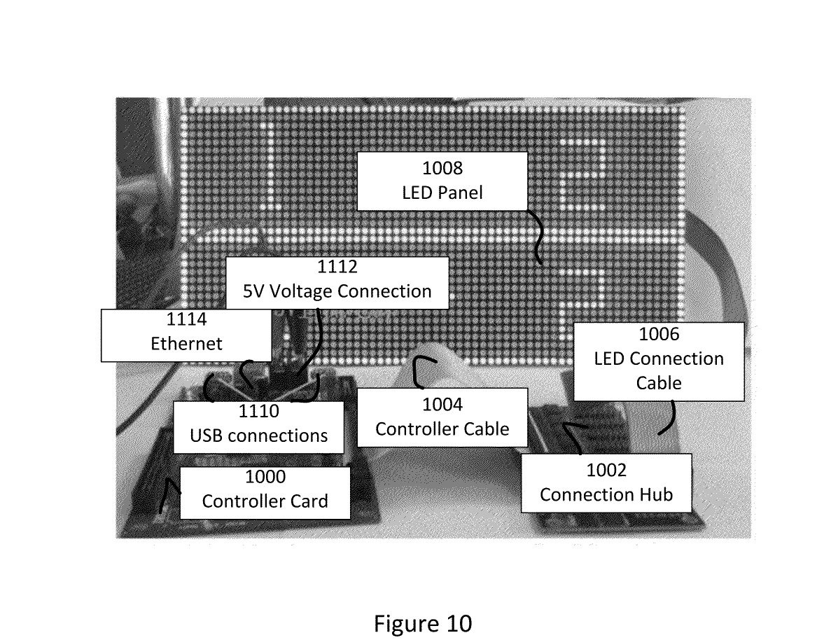

With reference now to FIGS. 10-28, the process of programming a light box comprising a controller card 1000, and LED module 1008 is described. The controller card 1000 is connected to the connection hub 1002 through controller cable 1004. The LED panel 1008 is connected to the connection hub 1002 using the LED connection cable 1006. The controller card 1000 has a plurality of USB connections 1110, an Ethernet module 1114, and 5 V power connection 1112. When connected and powered on, the controller card's 1000 power light will illuminate and the lights on the Ethernet module 1114 will begin to flash.

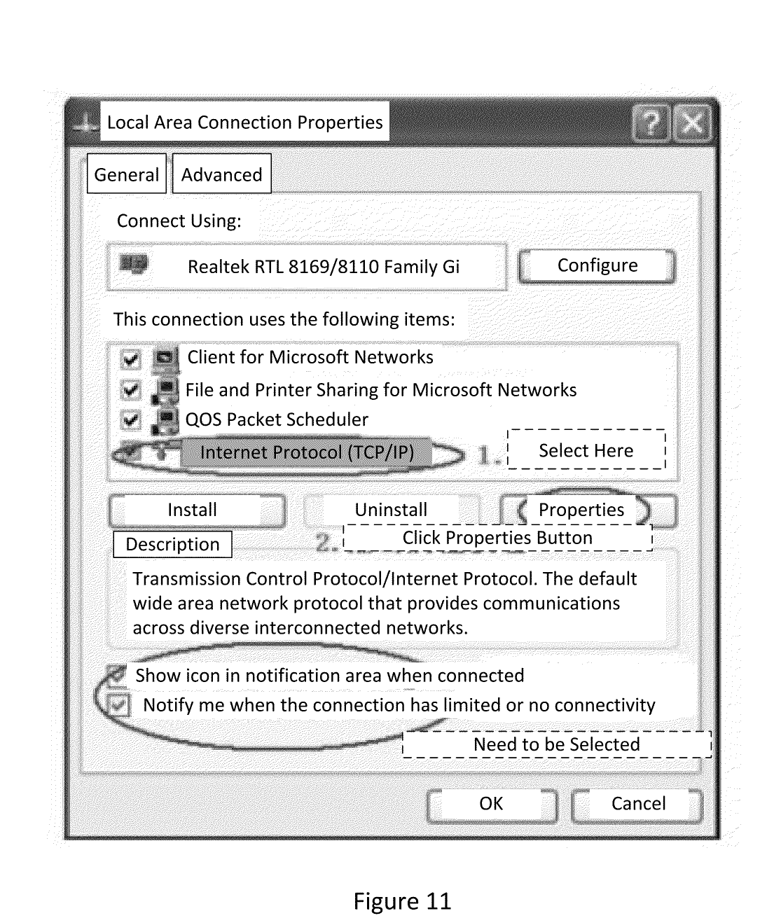

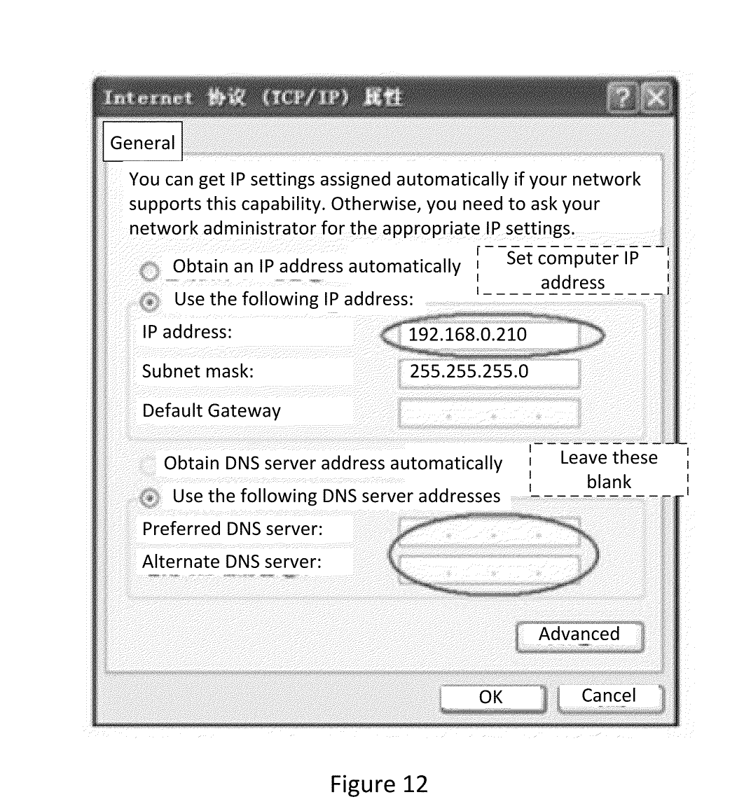

With reference now to FIGS. 11-27, one embodiment of the process of configuring a light box using a computer running Microsoft Windows XP is provided. First the user must configure the IP settings of the controller card as shown in FIG. 11. The user must open “Network Connections” in “My Network Places” and select the “Properties” option for “Internet Protocol (TCP/IP)”. Then, as shown in FIG. 12, the user may continue to configure the IP address settings. The user must enter the IP address of the computer while leaving the DNS options blank. The standard IP is 192.168.0.210. The user may then select “OK” to finish configuring the PC IP settings.

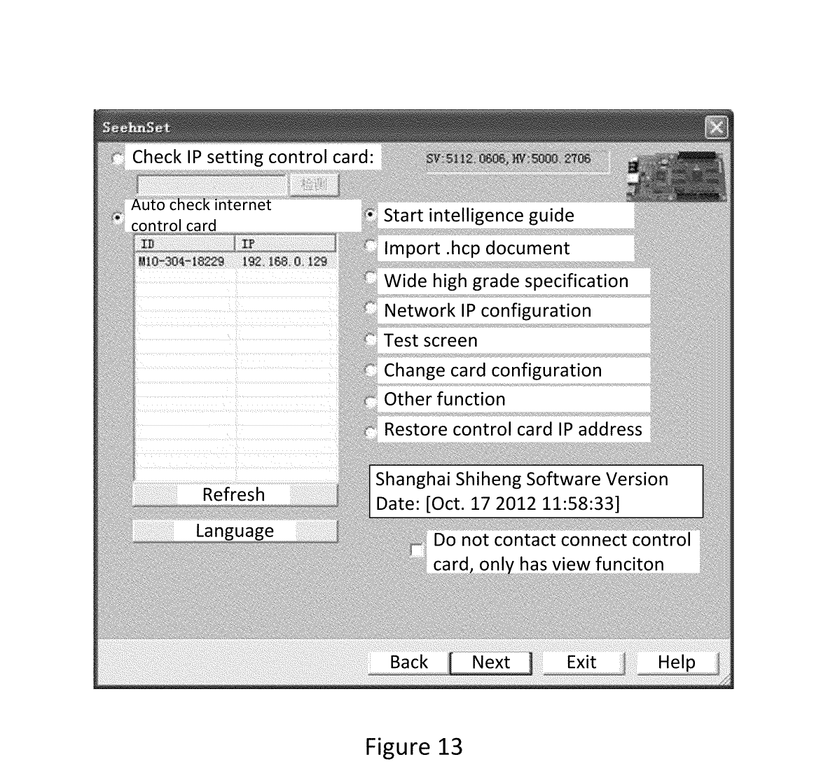

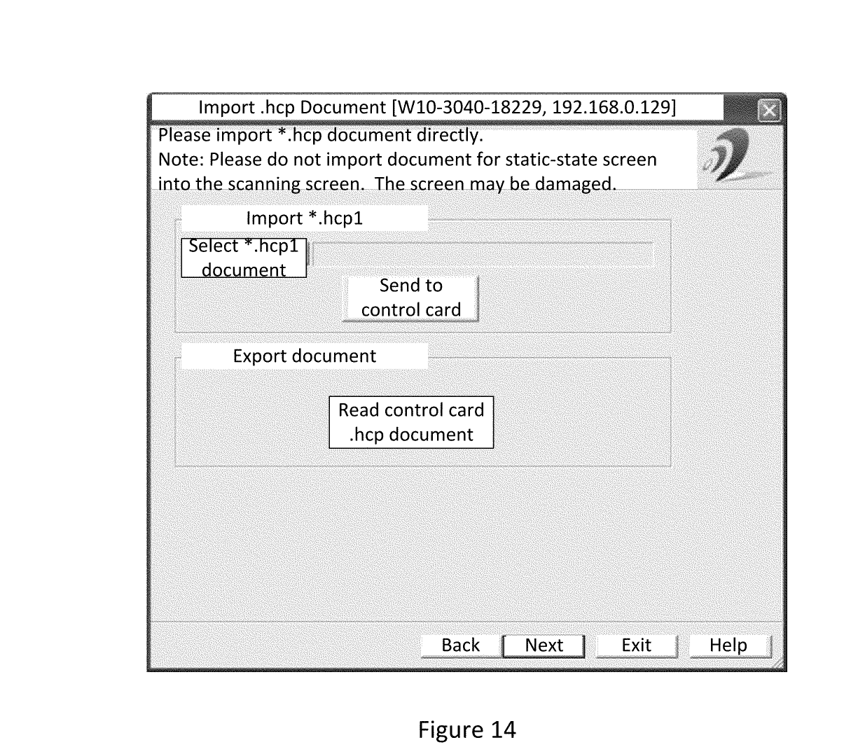

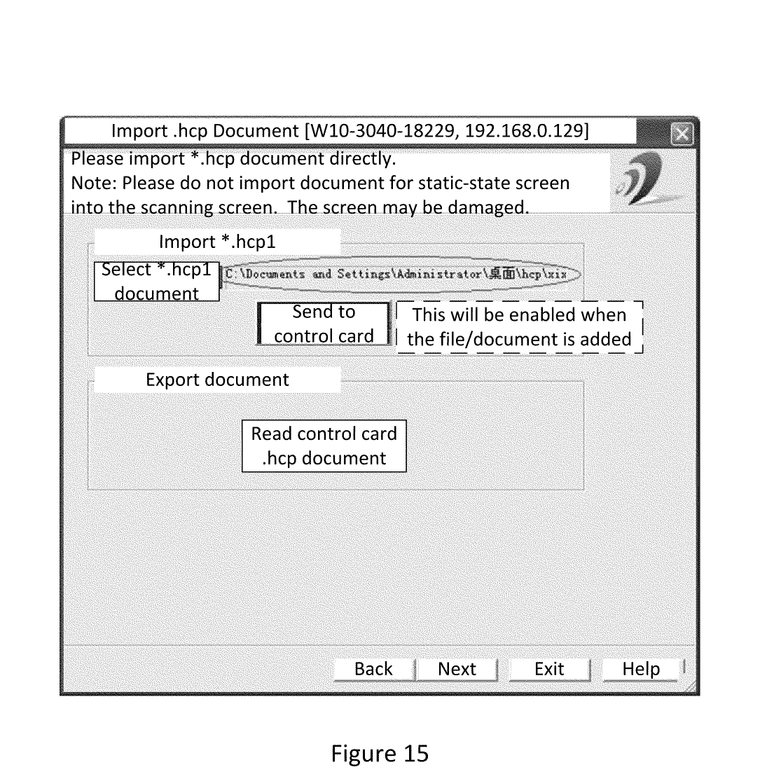

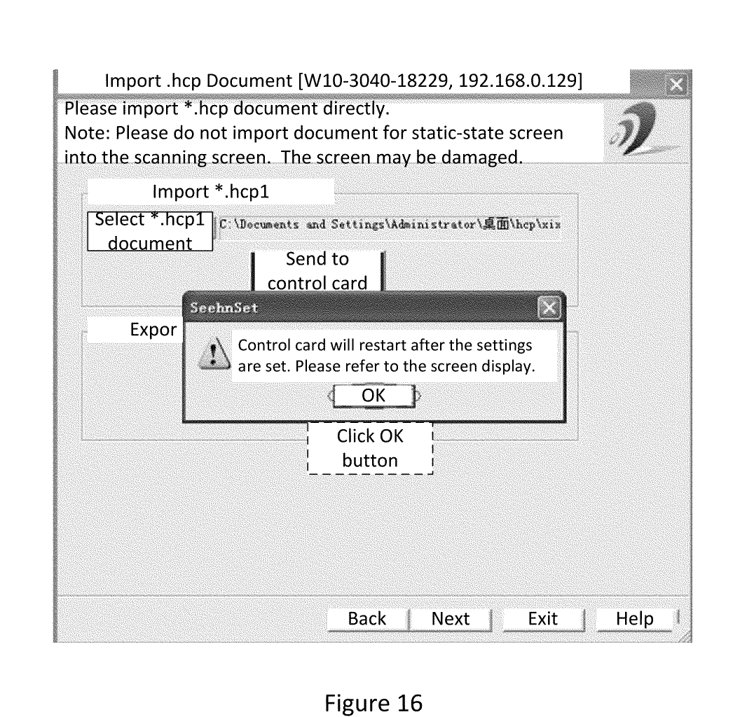

Continuing to FIG. 13, if a display has been fully configured, “*.hcp” files can be uploaded directly. To upload a *.hcp file, a user first opens the software “SeehnSet exe” and is provided the interface as shown in FIG. 13. The user then selects a *.hcp file to upload and selects “continue” to the next step as shown in FIG. 14. The user chooses the desired *.hcp file when prompted and at this time, the button “send to control card” is activated as shown in FIG. 15. The user is then prompted to select “OK” as shown in FIG. 16 to program and restart the controller card.

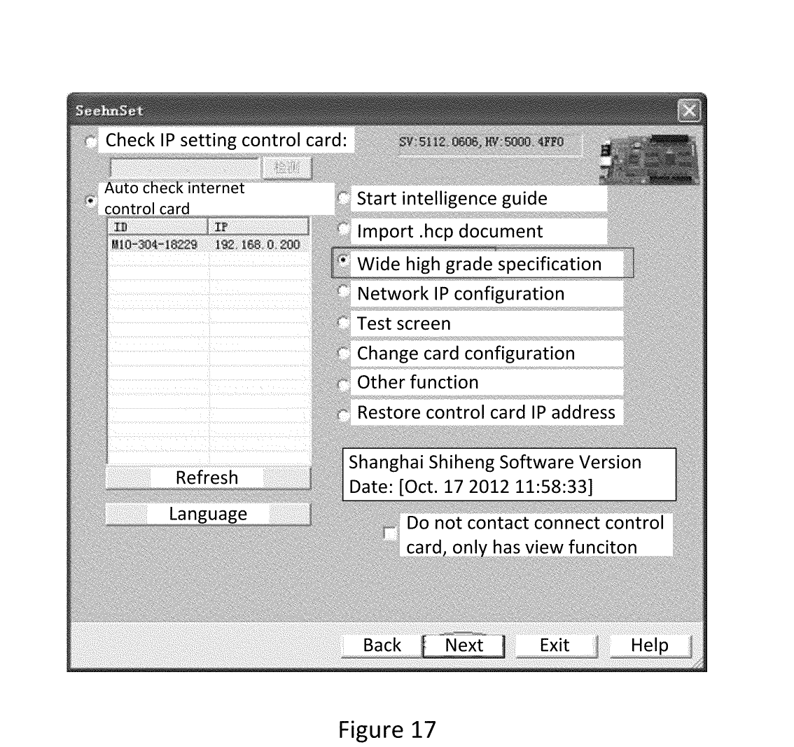

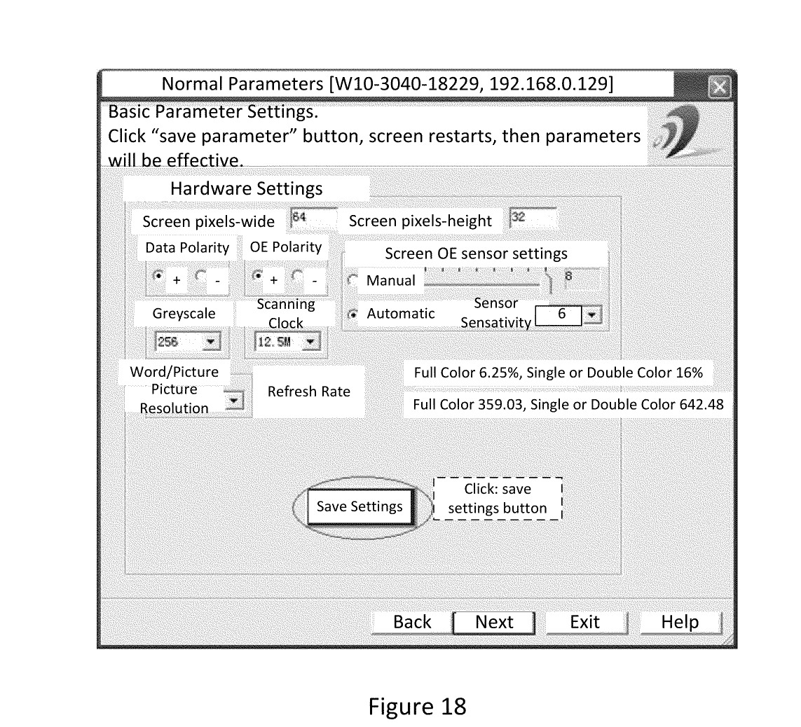

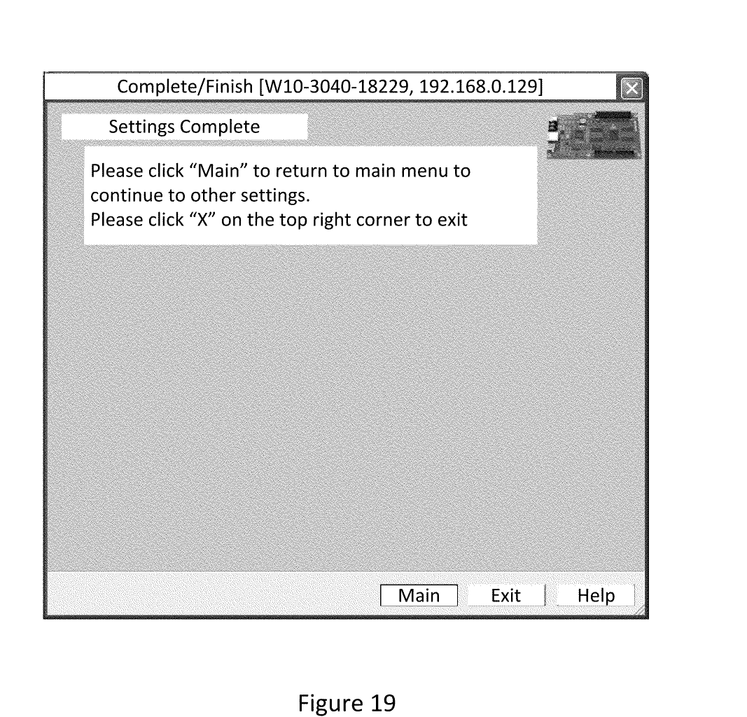

With reference now to FIG. 17, if a display has not been fully configured, the user may configure the settings for the display. To set the size of the display the user first opens the smart setting interface as shown in FIG. 17, and selects the wide high grade specification option as indicated by the red box. The user then selects “Next” to open “common settings” and then complete the settings by entering the appropriate data in the interface shown in FIG. 18. The user may then save the setting by selecting “Save Settings” as shown in FIG. 18. At this time, the screen is re-started. Acknowledgement of the settings being saved is provided to the user as shown in FIG. 19. The user may then select “Back” to set other settings. If no other settings changes are required, the user may select “Exit”.

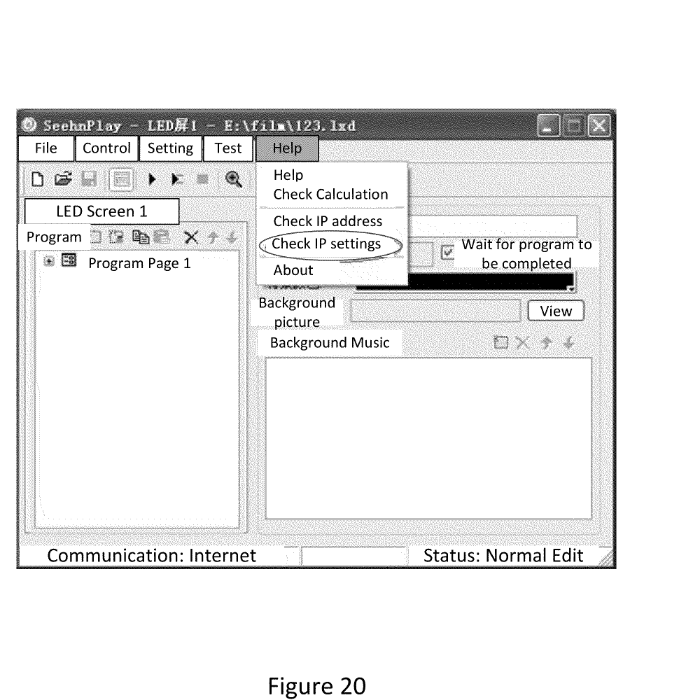

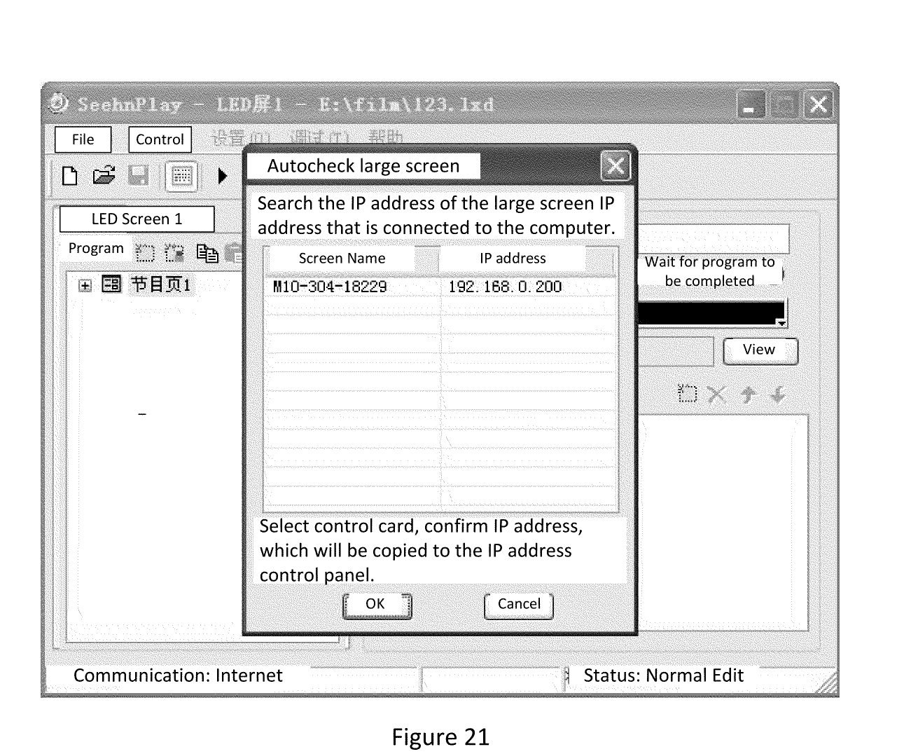

To continue with programming the display, in one embodiment the user may then start the “SeehnPlay” software and select the “Menu” button, and a user interface will be provided as shown in FIGS. 20 and 21. From this interface the user may set and confirm the IP address of the display being programmed. To do so, the user would select “Help” and then “Check IP settings”. As seen in FIG. 21, the IP of the display is shown as 192.168.0.200.

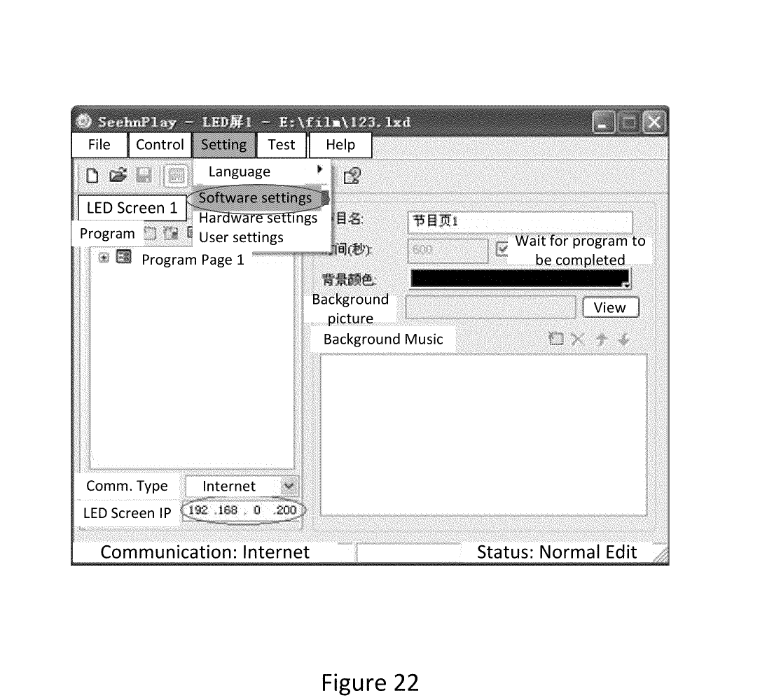

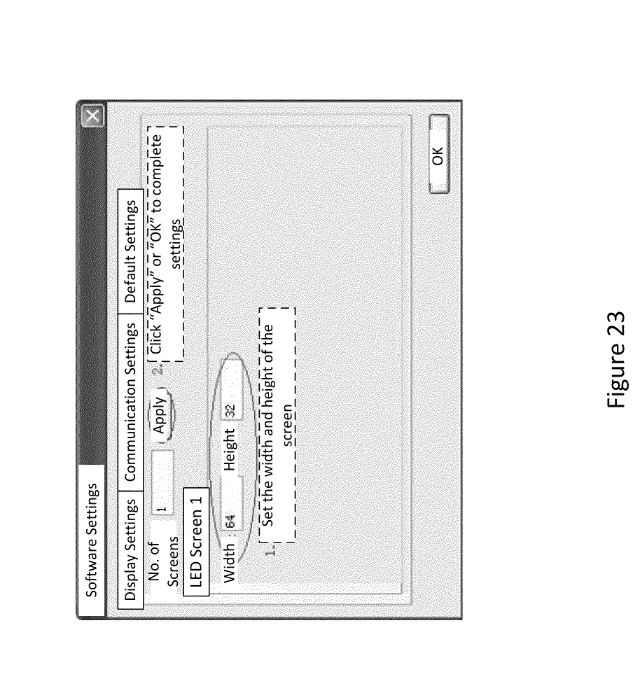

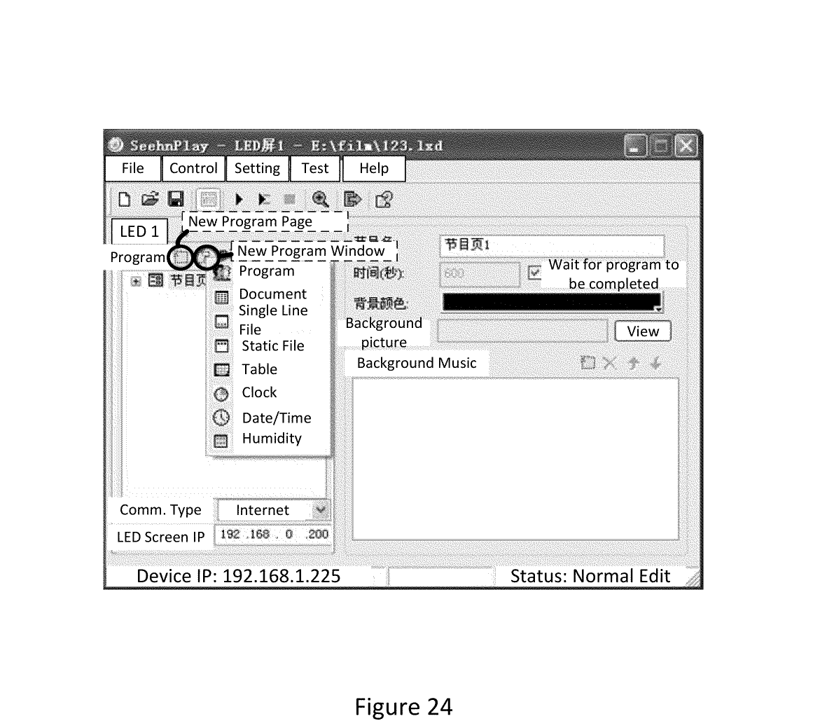

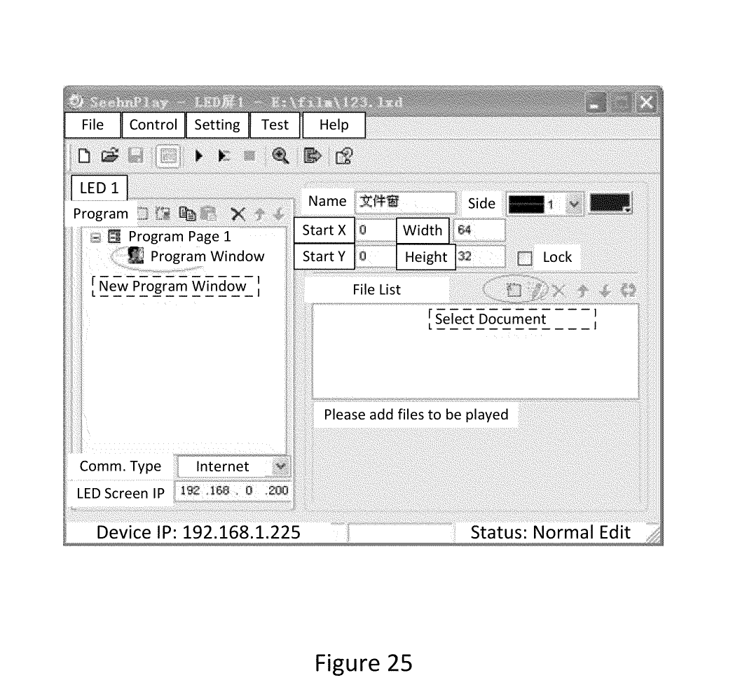

To program a text window using the SeehnPlay software, the user would first select “Settings” and then proceed to “Software settings” as shown in FIG. 22. To change settings for the text display, the user is provided the interface as shown in FIG. 23. The user then needs to make a “Text Window” item. To do this, the user selects “New Program Page” as shown in FIG. 24 and then selects “Program” to make a new “Text Window” item. The user then selects the “Program Window” under “Program Page 1”, and then selects the “Select Document” button in the “File List” menu as shown in FIG. 25 to edit the program window parameters.

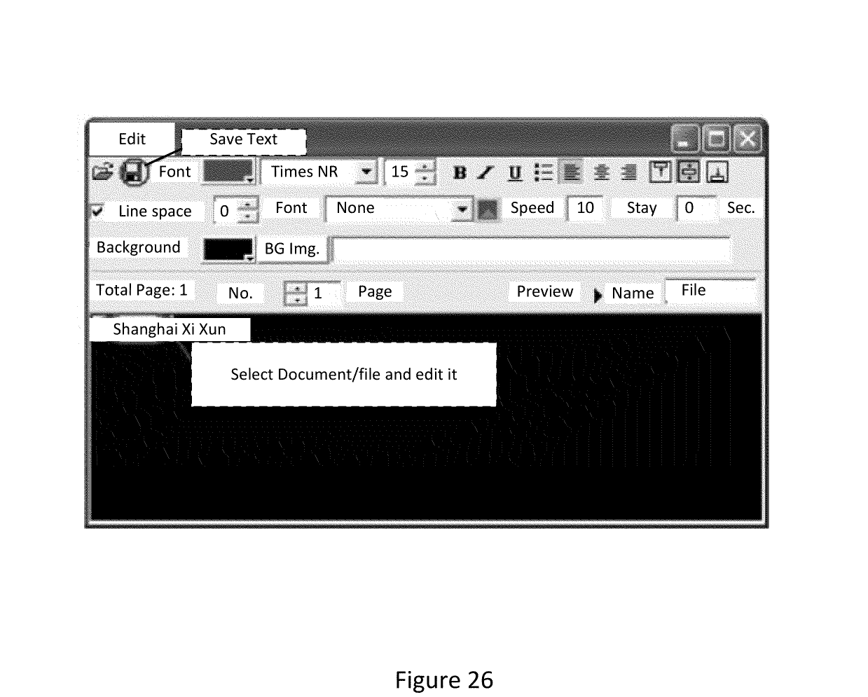

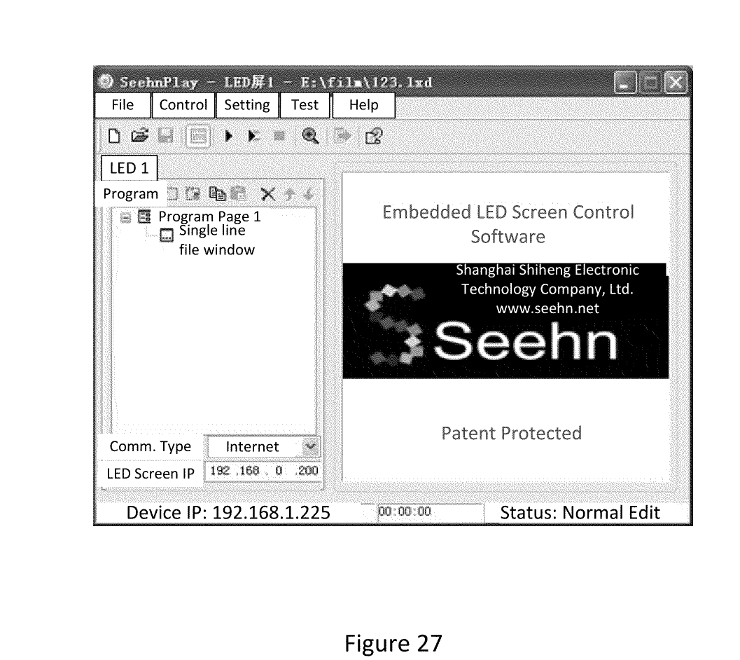

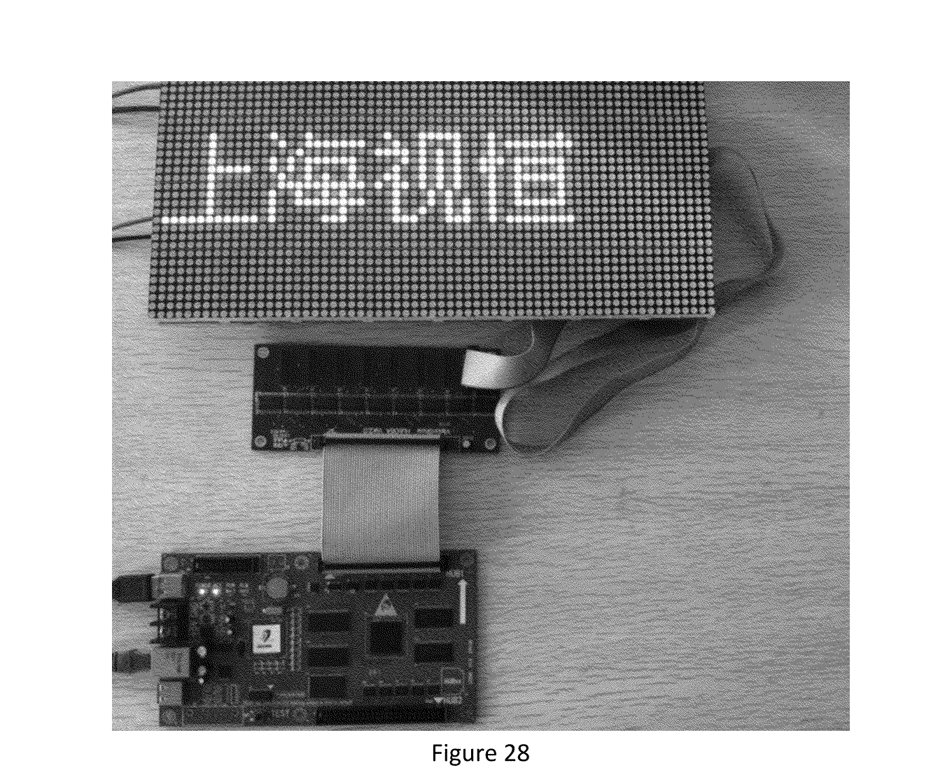

Once the “Select Document” option has been selected, an “Item Edit Window” as shown in FIG. 26 is provided to the user. The “Item Edit Window” as shown in FIG. 26 allows a user to edit the text to be displayed. The user may set the size, font, speed, scroll type, and other aspects of the text in the “Item Edit Window”. The user may then save the edited text, and save the program as shown in FIG. 27. The saved program is now ready to be sent to the LED display using the “Send” option in the menu. After the hardware connection is completed the finished program can be sent to and shown on the LED display as shown in FIG. 28.

While the invention has been described by reference to certain preferred embodiments, it should be understood that numerous changes could be made within the spirit and scope of the inventive concept described. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. An LED display comprising:
a display panel comprising:
a transparent layer;
a light sheet layer;
a set of LED modules;
an opaque back panel;
a supporting structure;
a controller card comprising:
a data interface module;
a communications module;
a controller module; and
a housing.

2. The LED display of claim 1 wherein the display is between 3.2 and 10 mm thick.

3. The LED display of claim 1 wherein the LED module comprises a plurality of LED lights and is operatively connected to the controller card.
